(19) United States
(12) Patent Application Publication
(10) Pub. No.: US 2019/0150416 A1
(43) Pub. Date: May 23, 2019

(54) FISHING LINE HOLDER

(71) Applicant: Roger Jeffery, Lehi, UT (US)

(72) Inventor: Roger Jeffery, Lehi, UT (US)

(21) Appl. No.: 16/112,009

(22) Filed: Aug. 24, 2018

Related U.S. Application Data
(60) Provisional application No. 62/589,783, filed on Nov. 22, 2017.

(51) Int. Cl. A01K 87/04

(52) U.S. Cl. CPC A01K 87/04

(57) ABSTRACT

A fishing line holder may provide a low-profile mount and a plurality of interacting elastomeric bodies which are supported to form a crease sufficient to hold a fishing line. Various methods of assembly may be employed.

### CROSS-REFERENCES TO RELATED APPLICATIONS

The present Application claims priority as a non-provisional perfection of prior filed U.S. Application No. 62/589,793, filed Nov. 11, 2017, and incorporates the same by reference in its entirety.

### FIELD OF THE INVENTION

The present invention relates to the field of fishing and more particularly relates to a rod mounted line holder.

### BACKGROUND OF THE INVENTION

When fishing with a rod, there is a frequent need to control the fishing line. Modern fishing line is usually thin and somewhat translucent, which makes it hard to see and grasp. Frequently, an angler may lose track of a line when repairing, baiting, or performing some other work on the line. To this end, various fishing line holders have been developed to hold the line while an angler works on it, or just to stow the line at the end of the day. The present invention is a holder for fishing line so that it may be stowed or just held so that the angler may work on the line.

Previous line holders tend to be hooks mounted upon the rod. Unfortunately, these hook structures tend to be very low-profile and difficult to locate on the fishing rod. They also have no inherent retention capability—the hook must interact with the fish hook or have the line wrapped around it. The combination makes these line holders difficult to use.

The present invention represents a departure from the prior art in that the fishing line holder of the present invention allows for minimal alteration of the fishing rod, a resilient line retention structure, and an in-line connection system which holds the entire structure together, resulting in an unobtrusive, easily manufactured, and easily installed line holder.

### SUMMARY OF THE INVENTION

In view of the foregoing disadvantages inherent in the known types of fishing line holder, an improved line holder may provide a dual-bodied elastomeric holding structure which will retain a line in a crease between the two elastomeric bodies. The line holder should meet the following objectives: it should have a low profile to be as unobtrusive as possible, yet easy to see and locate; it should be simple and intuitive in installation and use; and it should be inexpensive to manufacture. As such, a new and improved line holder may comprise two rounded elastomeric bodies held together on the holder mount by a bolt which squeezes them together, forming a crease therebetween in which to stow the line to accomplish these objectives.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in many ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a partial fishing rod with an embodiment of a fishing line holder installed thereupon.

FIG. 2 is a detail view of the fishing line holder in FIG. 1, taken in circle II.

FIG. 3 is a side elevational view if the fishing line holder of FIG. 2.

FIG. 4 is a sectional view of the fishing line holder of FIG. 3, taken on line IV-IV.

FIG. 5 is a top plan view of the fishing line holder of FIG. 2.

FIG. 6 is a bottom plan view of the fishing line holder of FIG. 2.

FIG. 7 is an exploded view of the fishing line holder of FIG. 2.

FIG. 8 is an exploded view of an alternate embodiment fishing line holder.

FIG. 9 is an exploded view of a further alternate embodiment fishing line holder.

FIG. 10 is a perspective view of another alternate embodiment fishing line holder.

FIG. 11 is a detail view of the fishing line holder of FIG. 10, taken in circle XI.

FIG. 12 is an exploded view of the fishing line holder of FIG. 11.

### DETAILED DESCRIPTION OF THE PREFERRED EMBODIMENT

With reference now to the drawings, a preferred embodiment of the fishing line holder is herein described. It should be noted that the articles “a”, “an”, and “the”, as used in this specification, include plural referents unless the content clearly dictates otherwise.

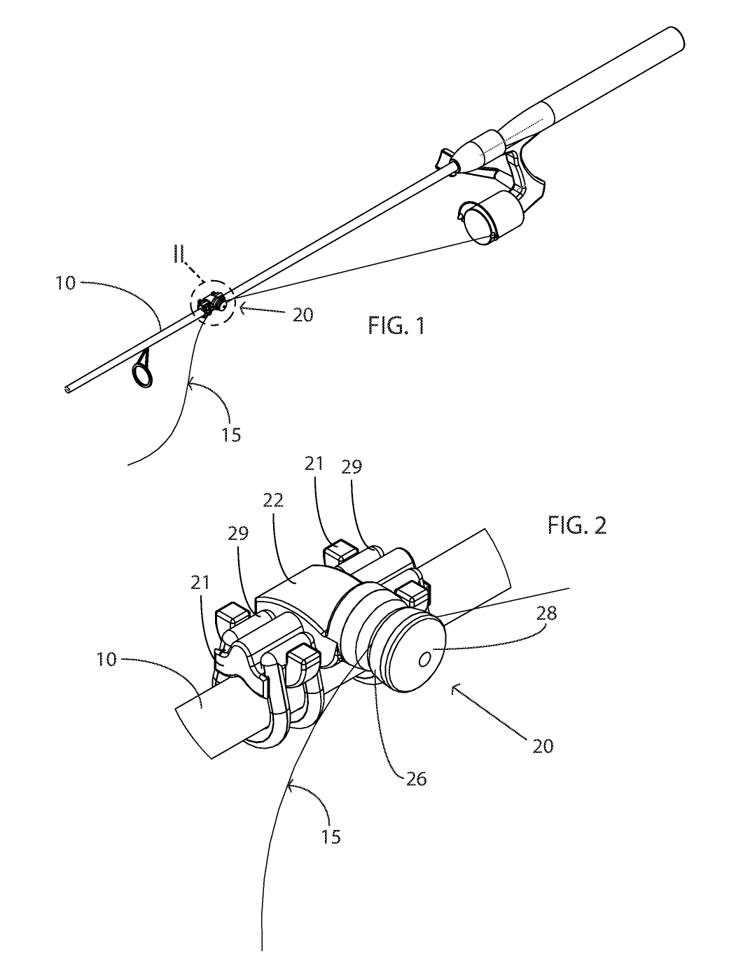

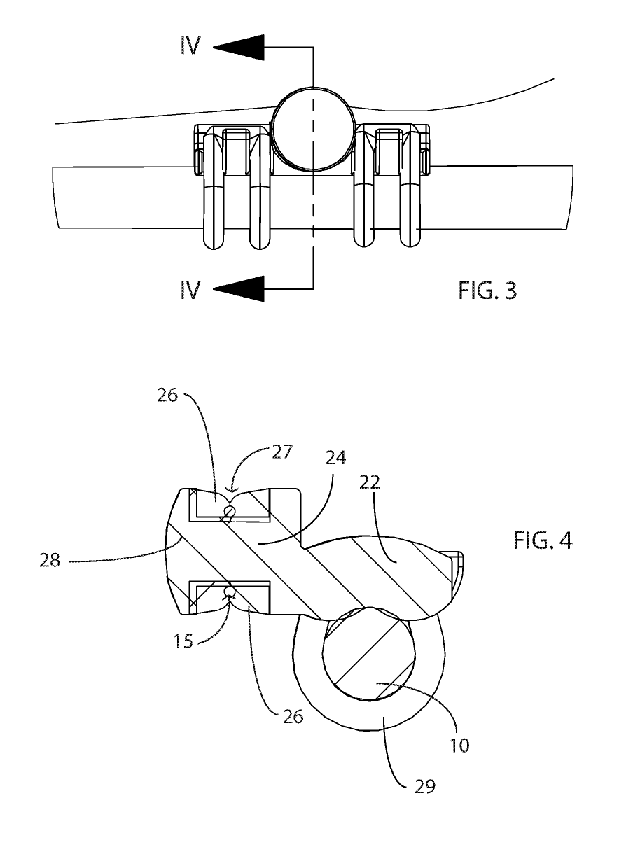

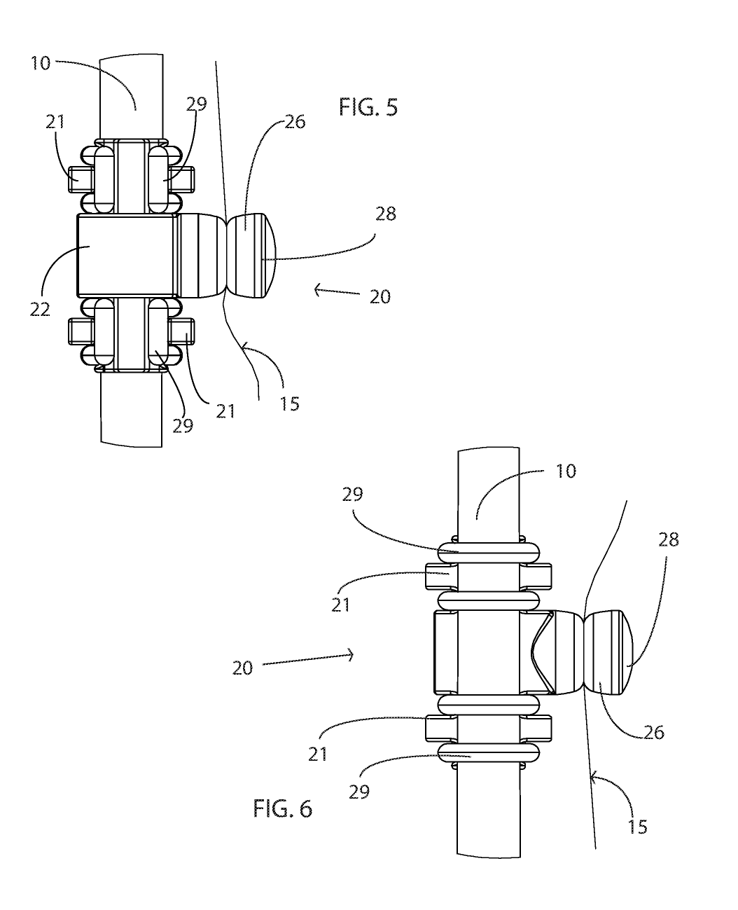

With reference to FIG. 1, a fishing rod 10 has a line 15 which may interface with an installed fishing line holder 20. In one embodiment, shown in FIGS. 2-6, the line holder 20 features a line holder body with a slightly concave underside and two shoulders 21. The concave underside of the body 22 and shoulders 21 assists the line holder 20 in having as low a profile as possible while the shoulders 21 provide anchors for two elastomeric bands 29 to wrap around the fishing rod 10 and secure the line holder 20 thereon. The line holder body also features a cantilever neck 24, extending perpendicularly from the shoulders 21, with a head 28 on its end. The head 28 and line holder body 22 then define a space along the neck 24. The neck 24 provides a support for two abutting elastomeric washers 26 located in the space between the head 28 and body 22. The juncture of the elastomeric washers 26 forms a crease 27 into which a fishing line 15 may be secured. Ultimately it is preferred that crease 27 be in-line, or parallel, with the rod 10 as this tends to keep a lower profile, though a perpendicular orientation could also be utilized.

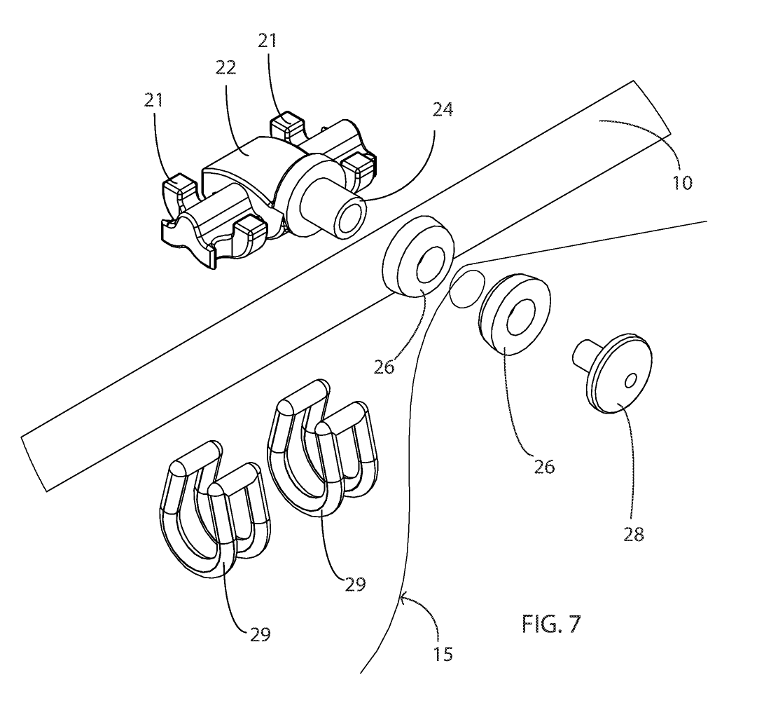

Various methods of securing the head 28 to the neck 24 (and thus the elastomeric washers thereon) may be employed. One method, shown in FIG. 7, shows the head 28 and neck 24 being two separate pieces. In this embodiment, the elastomeric washers 26 may simply be positioned upon the neck 24 against the body 22 and the head secured to the neck 24 by means of an adhesive, ultrasonic welding, chemical bonding (such as with PVC cement if the line holder were made of PVC), or any other method now know or otherwise later discovered. In this manner, the elastomeric washers 26 are not stressed in any way through the installation process.

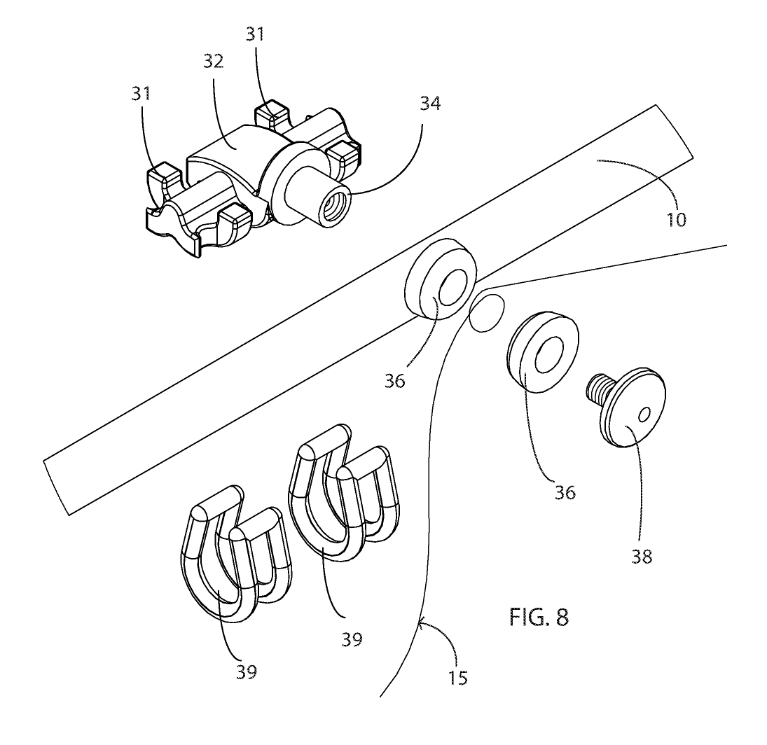

An alternate means of securing the head 38 to the neck 34 is shown in FIG. 8 where they have a threaded interface. In this way, should the elastomeric washers ever need replaced, the head 38 may be simply unscrewed to be removed and allow maintenance. All other features of this threaded line holder are similar to the first line holder 20 in that it has the same body 32, shoulders 31 and bands 39. This embodiment has the advantage of not only having easy installation of the elastomeric washers 36, but also removal or tightening of the same to accommodate different weight of line. Other detachable methods of attachment may be used, such as a bayonet interface.

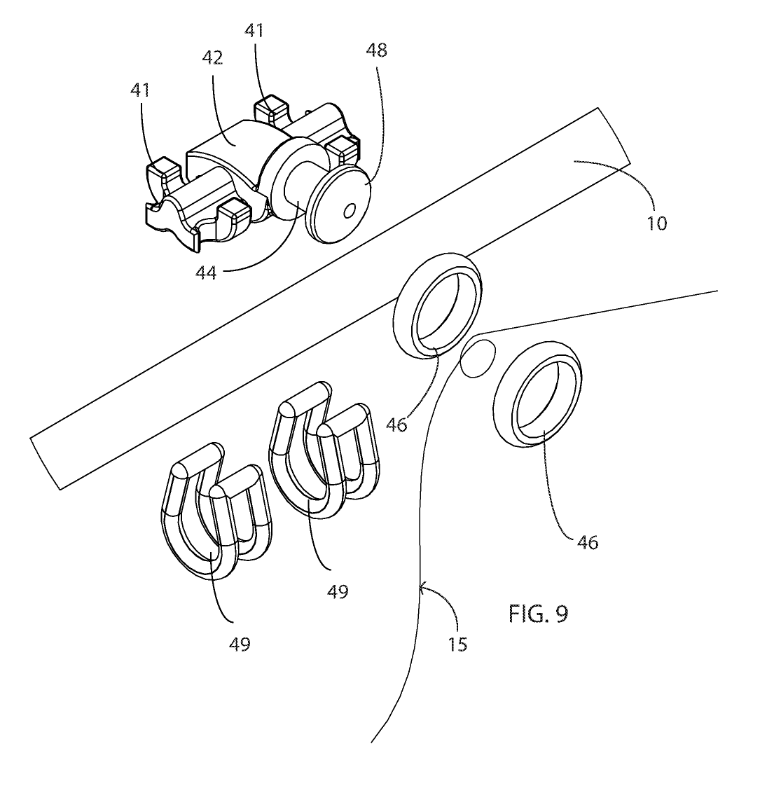

A third embodiment (FIG. 9) has the head 48 and neck 44 fused together permanently as one piece. Elastomeric washers 46 must then slip over the head 48 to rest against each other and the body 42. While difficult to position the elastomeric washers 46, or replace them, this embodiment has the advantage of being a simple, single piece to manufacture.

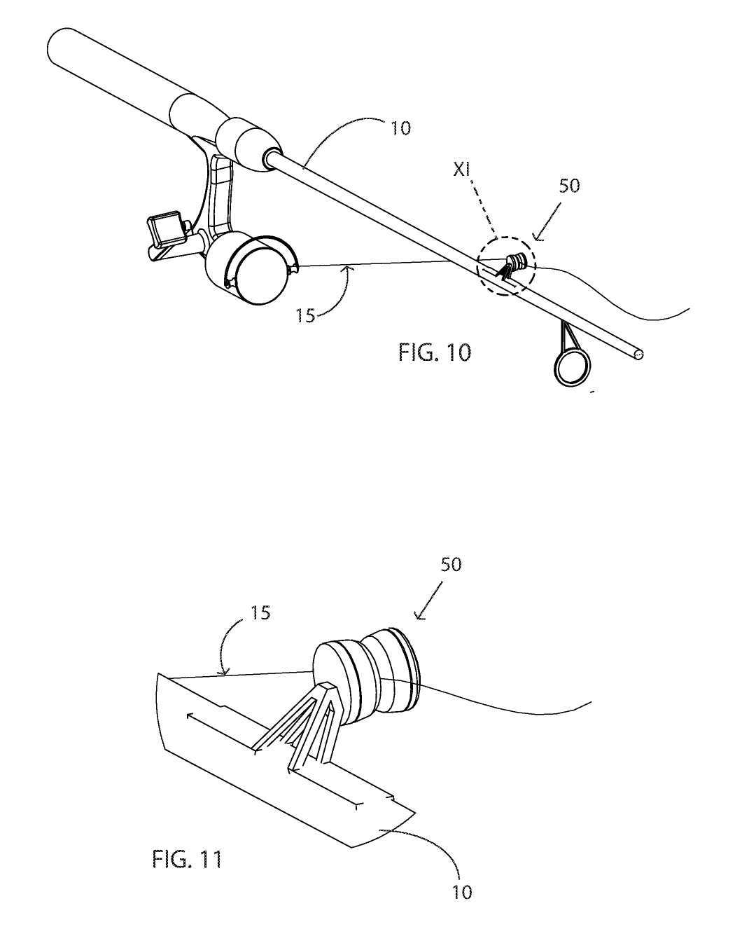

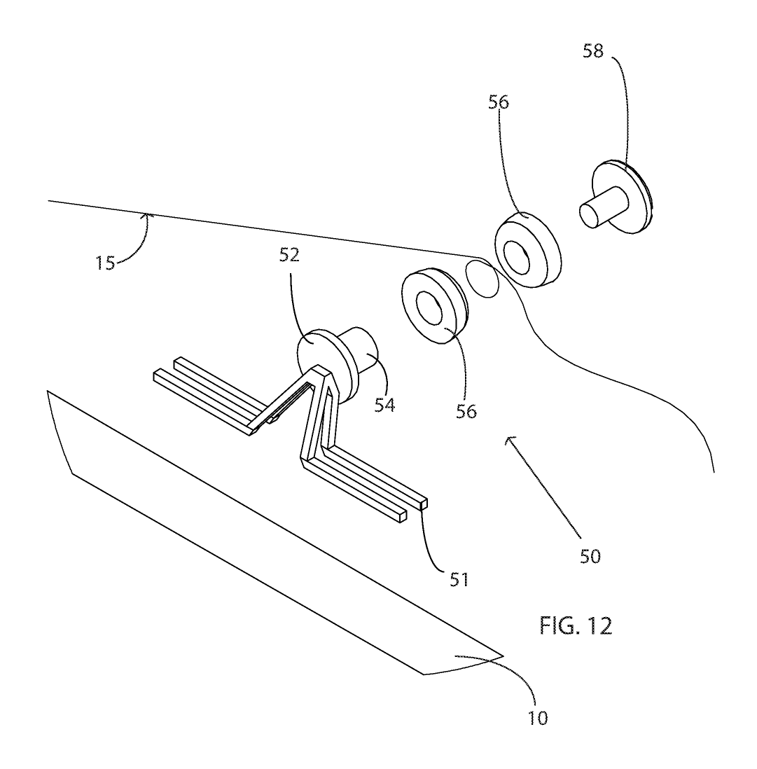

An alternate mounting embodiment, shown in FIGS. 10-12, may also be employed. Instead of having a central body and shoulders, as the first embodiment did, this alternate embodiment 50 may feature a rack made of two sets of anchor legs 51 on each side of a mount body 52. These anchor legs 51 may project as far or as close to the mount body as a designer may desire. The opposed legs 51 in each set may then fit around the circumference of a fishing rod 10 and be secured by any means known or later discovered, with simple tape or another wrapping technology being preferred. As with the previous embodiments, a neck 54 and head 58 are presented as are two elastomeric washers 56. The attachment strategies of the head 58 and neck 54 are understood to be the same as presented before.

With any embodiment, and referring again to FIGS. 2-6, fishing line 15 may then be held in the crease 27 between the two elastomeric washers 26. The tightness of the elastomeric washers 26 would then affect the ability of the crease 27 to accept larger and smaller weight of line and the inherent friction of the elastomeric bodies 26 would suffice to hold the line 15 with one partial wrap around the crease 27, so long as the line 15 entered the crease 27. When the angler wishes to fish again, line 15 is easily removed therefrom.

The depicted elastomeric washers are preferred to be toroids rounded on their interactive side and flat on their opposite side. This is to provide more efficient interaction with the bolt and the mount body while also providing a tighter crease towards the bolt as opposed to, radially, away from the bolt. This allows for a greater variety of line thicknesses to be secured within the crease 27 and prevents line 15 from entering into the crease 27 too deeply. However, any shape of elastomeric body, including a fully round toroid, can be used with varying effects. Any sufficiently elastomeric material which would provide a sufficient crease 27 when the two washers 26 are abutting each other may be used.

The line holder body 20 may be made of any material useful and efficient in the construction of the same. As such, polymers are preferred, though metals and/or combinations of the same may be employed. The resulting holder needs to be as unobtrusive as possible so as to not interfere with the line while the rod is in use and not encumber the rod or hinder its mobility while casting.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A fishing line holder comprising:
a. a line holder body;
b. a neck extending cantileverally from the line holder body;
c. a head residing on an end of the neck, defining a space between the head and line holder body along the neck; and
d. two elastomeric washers residing in the space between the line holder body and the head, the elastomeric washers abutting each other to form a crease;
wherein fishing line may be temporarily secured within the crease.

2. The fishing line holder of claim 1, further comprising two opposed shoulders extending from the line holder body, perpendicular to the neck, with both shoulders and the line holder body sharing a concave surface and two elastomeric bands which then mount upon the shoulders about a fishing rod.

3. The fishing line holder of claim 2, the head and neck being separate, detachable pieces.

4. The fishing line holder of claim 3, the head and neck being joined by a threaded interface.

5. The fishing line holder of claim 2, the head and neck being two separate pieces permanently joined together.

6. The fishing line holder of claim 1, further comprising a rack of attachment legs extending from the line holder body.

7. The fishing line holder of claim 6, the head and neck being separate, detachable pieces.

8. The fishing line holder of claim 7, the head and neck being joined by a threaded interface.

9. The fishing line holder of claim 6, the head and neck being two separate pieces permanently joined together.

10. The fishing line holder of claim 1, the head and neck being separate, detachable pieces.

11. The fishing line holder of claim 10, the head and neck being joined by a threaded interface.

12. The fishing line holder of claim 1, the head and neck being two separate pieces permanently joined together.
